(19) United States
(12) Patent Application Publication
(10) Pub. No.: US 2009/0055169 A1
(43) Pub. Date: Feb. 26, 2009

(54) VOICE ENCODING DEVICE, AND VOICE ENCODING METHOD

(75) Inventors: Michiyo Goto, Tokyo (JP); Koji Yoshida, Kanagawa (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/814,833

(22) PCT Filed: Jan. 25, 2006
(86) PCT No.: PCT/JP2006/301154

§ 371 Date: Jul. 26, 2007

(30) Foreign Application Priority Data
Jan. 26, 2005 (JP) 2005-018150

(51) Int. Cl. G10L 11/00

(52) U.S. Cl. 704/200

(57) ABSTRACT

A voice encoding device capable of generating a modulated proper monaural signal enriched in clearness and understandability, when the monaural signal is to be generated from a stereophonic signal. In this device, a weighting unit (11) weights an L-channel signal (X_{L}) and an R-channel signal (X_{R}) individually, and inputs the weighted L-channel signal (X_{LW}) and R-channel signal (X_{RW}) to a monaural signal generating unit (12). This monaural signal generating unit (12) averages the L-channel signal (X_{LW}) and the R-channel signal (X_{RW}), and creates and inputs a monaural signal (X_{MW}) to a monaural signal encoding unit (13). This monaural signal encoding unit (13) encodes the monaural signal (X_{MW}), and outputs an encoding parameter of the monaural signal (X_{MW}) (or a monaural signal encoding parameter).

### TECHNICAL FIELD

The present invention relates to a speech encoding apparatus and a speech encoding method. More particularly, the present invention relates to a speech encoding apparatus and a speech encoding method that generate a monaural signal from a stereo speech input signal and encode the signal.

### BACKGROUND ART

As broadband transmission in mobile communication and IP communication has become the norm and services in such communications have diversified, high sound quality of and higher-fidelity speech communication is demanded. For example, from now on, hands free speech communication in a video telephone service, speech communication in video conferencing, multi-point speech communication where a number of callers hold a conversation simultaneously at a number of different locations and speech communication capable of transmitting the sound environment of the surroundings without losing high-fidelity will be expected to be demanded. In this case, it is preferred to implement speech communication by stereo speech which has higher-fidelity than using a monaural signal, is capable of recognizing positions where a number of callers are talking. To implement speech communication using a stereo signal, stereo speech encoding is essential.

Further, to implement traffic control and multicast communication in speech data communication over an IP network, speech encoding employing a scalable configuration is preferred. A scalable configuration includes a configuration capable of decoding speech data even from partial coded data at the receiving side.

As a result, even when encoding and transmitting stereo speech, it is preferable to implement encoding employing a monaural-stereo scalable configuration where it is possible to select decoding a stereo signal and decoding a monaural signal using part of coded data at the receiving side.

In speech encoding having a monaural-stereo scalable configuration, a monaural signal is generated from a stereo input signal. For example, as methods of generating monaural signals, there is a method where signals of each channel of a stereo signal are simply averaged to obtain a monaural signal (refer to non-patent document 1).

Non-patent document 1: ISO/IEC 14496-3, “Information Technology—Coding of audio-visual objects—Part 3: Audio”, subpart-4, 4.B.14 Scalable AAC with core coder, pp. 304-305, December 2001.

### DISCLOSURE OF THE INVENTION

### Problems to be Solved by the Invention

However, when signals of each channel of a stereo signal are averaged as is so as to generate a monaural signal, this results in a poorly defined monaural signal that is difficult to listen to, particularly for speech.

It is therefore an object of the present invention to provide a speech encoding apparatus and a speech encoding method capable of generating an appropriate monaural signal that is clear and intelligible when generating a monaural signal from a stereo signal.

### Means for Solving the Problem

The speech encoding apparatus of the present invention adopts a configuration having: a weighting section that assigns weights to signals of each channel using weighting coefficients according to a speech information amount of signals for each channel of a stereo signal; a generating section that averages weighted signals for each of the channels so as to generate a monaural signal; and an encoding section that encodes the monaural signal.

### ADVANTAGEOUS EFFECT OF THE INVENTION

According to the present invention, it is possible to generate an appropriate monaural signal that is clear and intelligible when generating a monaural signal from a stereo signal.

### DETAILED DESCRIPTION OF THE DRAWINGS

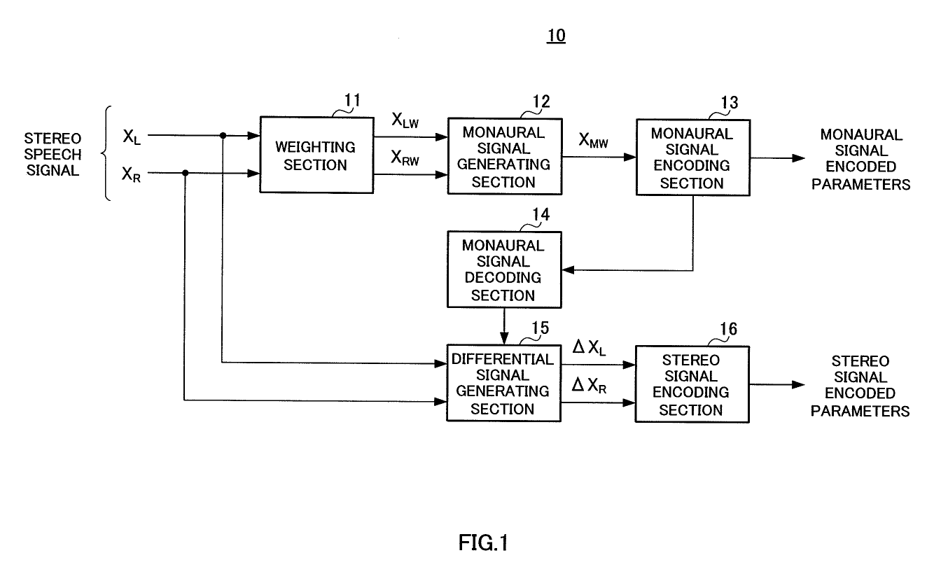

FIG. 1 is a block diagram showing a configuration of a speech encoding apparatus according to Embodiment 1 of the present invention;

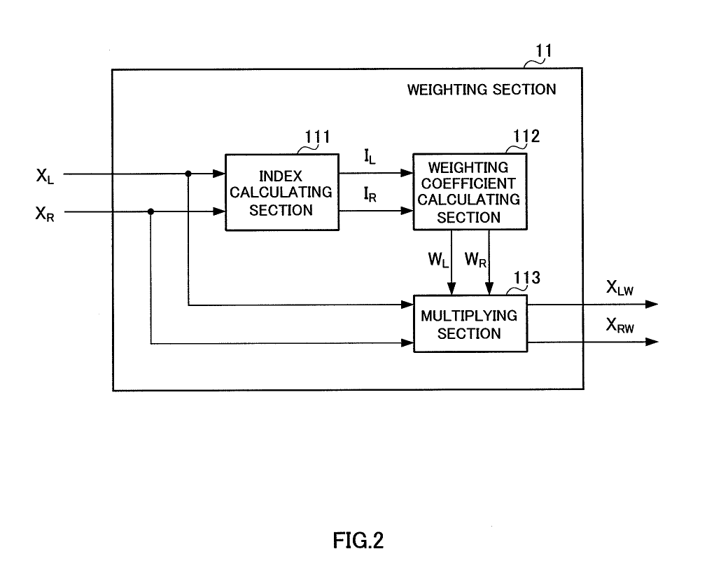

FIG. 2 is a block diagram showing a configuration of a weighting section according to Embodiment 1 of the present invention;

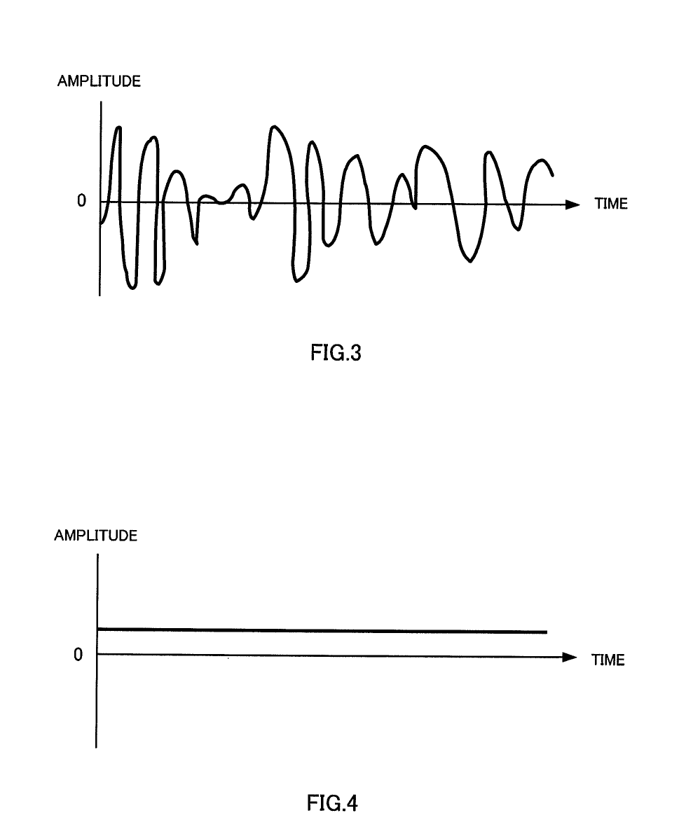

FIG. 3 is an example of a waveform for an L-channel signal according to Embodiment 1 of the present invention; and

FIG. 4 is an example of a waveform for an R-channel signal according to Embodiment 1 of the present invention.

### BEST MODE FOR CARRYING OUT THE INVENTION

Embodiments of present invention will be described in detail below with reference to the accompanying drawings.

### Embodiment 1

A configuration of a speech encoding apparatus according to this embodiment is shown in FIG. 1. Speech encoding apparatus 10 shown in FIG. 1 has weighting section 11, monaural signal generating section 12, monaural signal encoding section 13, monaural signal decoding section 14, differential signal generating section 15 and stereo signal encoding section 16.

L-channel (left channel) signal X_{L} and R-channel (right channel) signal X_{R} of a stereo speech signal are inputted to weighting section 11 and differential signal generating section 15.

Weighting section 11 assigns weights to L channel signal X_{L} and R-channel signal X_{R}, respectively. A specific method for assigning weights is described later. Weighted L-channel signal X_{LW} and R-channel signal X_{RW} are then inputted to monaural signal generating section 12.

Monaural signal generating section 12 averages L-channel signal X_{LW} and R-channel signal X_{RW} so as to generate monaural signal X_{MW}. This monaural signal X_{MW} is inputted to monaural signal encoding section 13.

Monaural signal encoding section 13 encodes monaural signal X_{MW}, and outputs encoded parameters (monaural signal encoded parameters) for monaural signal X_{MW}. The monaural signal encoded parameters are multiplexed with stereo signal encoded parameters outputted from stereo signal encoding section 16 and transmitted to a speech decoding apparatus. Further, the monaural signal encoded parameters are inputted to monaural signal decoding section 14.

Monaural signal decoding section 14 decodes the monaural signal encoded parameters so as to obtain a monaural signal. The monaural signal is then inputted to differential signal generating section 15.

Differential signal generating section 15 generates differential signal ΔX_{L} between L-channel signal X_{L} and the monaural signal, and differential signal ΔX_{R} between R-channel signal X_{R} and the monaural signal. Differential signals ΔX_{L} and ΔX_{R} are inputted to stereo signal encoding section 16.

Stereo signal encoding section 16 encodes L-channel differential signal ΔX_{L} and R-channel differential signal ΔX_{R} and outputs encoded parameters (stereo signal encoded parameters) for the differential signals.

Next, the details of weighting section 11 will be described using FIG. 2. As shown in this drawing, weighting section 11 is provided with index calculating section 111, weighting coefficient calculating section 112 and multiplying section 113.

L-channel signal X_{L} and R-channel signal X_{R} of the stereo speech signal are inputted to index calculating section 111 and multiplying section 113.

Index calculating section 111 calculates indexes I_{L} and I_{R} indicating a degree of the speech information amount of each channel signal X_{L} and X_{R} on a per fixed length of segment basis (for example, on a per frame basis or on a per plurality of frames basis). It is assumed that L-channel signal index I_{L} and R-channel signal index I_{R} indicate values in the same segments with respect to time. Indexes I_{L} and I_{R} are inputted to weighting coefficient calculating section 112. The details of indexes I_{L} and I_{R} are described in the following embodiment.

Weighting coefficient calculating section 112 calculates weighting coefficients for signals of each channel of the stereo signal based on indexes I_{L} and I_{R}. Weighting coefficient calculating section 112 calculates weighting coefficient W_{L} of each fixed length of segment for L-channel signal X_{L}, and weighting coefficient W_{R} of each fixed length of segment for R-channel signal X_{R}. Here, the fixed length of segment is the same as the segment for which index calculating section 111 calculates indexes I_{L} and I_{R}. Weighting coefficients W_{L} and W_{R} are then inputted to multiplying section 113.

$$\begin{matrix}[ 1 ] & \\ {W}_{L} = \frac{{I}_{L}}{{I}_{L} + {I}_{R}} & ( Equation 1 ) \\ [ 2 ] & \\ {W}_{R} = \frac{{I}_{R}}{{I}_{L} + {I}_{R}} & ( Equation 2 )\end{matrix}$$

Multiplying section 113 multiplies the weighting coefficients with the amplitudes of signals of each channel of the stereo signal. As a result, weights are assigned to the signals of each channel of the stereo signal using weighting coefficients according to the speech information amount for signals of each channel. Specifically, when the i-th sample within a fixed length of segment of the L-channel signal is X_{L}(i), and the i-th sample of the R-channel signal is X_{R}(i), the i-th sample X_{LW}(i) of the weighted L-channel signal and the i-th sample X_{RW}(i) of the weighted R-channel signal are obtained according to equations 3 and 4. Weighted signals X_{LW} and X_{RW} of each channel are then inputted to monaural signal generating section 12.

[3]

X_{LW}(i)=W_{L}·X_{L}(i) (Equation 3)

[4]

X_{RW}(i)=W_{R}·X_{R}(i) (Equation 4)

Monaural signal generating section 12 shown in FIG. 1 then calculates an average value of weighted L-channel signal X_{LW} and weighted R-channel signal X_{RW}, and takes this average value as monaural signal X_{MW}. Monaural signal generating section 12 then generates an i-th sample X_{MW}(i) for the monaural signal according to equation 5.

$$\begin{matrix}[ 5 ] & \\ {X}_{M W} ( i ) = \frac{{X}_{LW} ( i ) + {X}_{RW} ( i )}{2} & ( Equation 5 )\end{matrix}$$

Monaural signal encoding section 13 encodes monaural signal X_{MW}(i), and monaural signal decoding section 14 decodes the monaural signal encoded parameters so as to obtain a monaural signal.

When the i-th sample of the L-channel signal is X_{L}(i), the i-th sample of the R-channel signal is X_{R}(i), and the i-th sample of the monaural signal is X_{MW}(i), differential signal generating section 15 obtains differential signal ΔX_{L}(i) of the i-th sample of the L-channel signal and differential signal ΔX_{R}(i) of the i-th sample of the R-channel signal according to equations 6 and 7.

[6]

ΔX_{L}(i)=X_{L}(i)−X_{MW}(i) (Equation 6)

[7]

ΔX_{R}(i)=X_{R}(i)−X_{MW}(i) (Equation 7)

Differential signals ΔX_{L}(i) and ΔX_{R}(i) are encoded at stereo signal encoding section 16. A method appropriate for encoding speech differential signals such as, for example, differential PCM encoding may be used as a method for encoding differential signals.

Here, for example, when the L-channel signal is comprised of a speech signal as shown in FIG. 3 and the R-channel signal is comprised of silent (DC component only), L-channel signal comprised of a speech signal provides more information to the listener on the receiving side than the R-channel signal comprised of silence (DC component only). As a result, when the signals of each channel are averaged as is so as to generate a monaural signal as in the related art, this monaural signal becomes a signal whose amplitude of the L-channel signal is made half, and can be considered to be a signal with poor clarity and intelligibility.

With regards to this, in this embodiment, monaural signals are generated from each channel signal weighted using weighting coefficients according to an index indicating the degree of speech information for the signals of each channel. Therefore, the clarity and intelligibility for the monaural signal upon decoding and playback of monaural signals on the receiving side may increase for the larger speech information amount. By generating a monaural signal as in this embodiment, it is possible to generate an appropriate monaural signal which is clear and intelligible.

Further, in this embodiment, encoding having a monaural-stereo scalable configuration is performed based on the monaural signal generated in this way, and therefore the power of a differential signal between channel signal where the degree of the speech information amount is large and monaural signal is made smaller than the case where the average value of signals of each channel is taken as a monaural signal (that is, the degree of similarity between the channel signal where the degree of the speech information amount is large and monaural signal becomes high). As a result, it is possible to reduce encoding distortion with respect to this channel signal. Although power of a differential signal between another channel signal where the degree of the speech information amount is small and a monaural signal is larger than for the case where an average value of the signals of each channel is taken as a monaural signal, it is possible to provide bias in encoding distortion of each channel between channels, and reduce encoding distortion of signal for a channel with large speech information amount. It is therefore possible to reduce auditory distortion for the overall stereo signal decoded on the receiving side.

### Embodiment 2

In this embodiment, the case will be described where entropy of signals of each channel is used as an index indicating the degree of the speech information amount. In this case, index calculating section 111 calculates entropyas follows, and weighting coefficient calculating section 112 calculates weighting coefficients as follows. The encoded stereo signal is in reality a sampled discrete value, but has similar properties when handled as a consecutive value, and therefore will be described as a consecutive value in the following description.

An entropy of consecutive sample value x having probability density function p(x) is defined using equation 8.

$$\begin{matrix}[ 8 ] & \\ H ( X ) = - {\int }_{- ∞}^{∞} p ( x ) {log}_{2} p ( x ) d x ( bits \text{/} sample value ) & ( Equation 8 )\end{matrix}$$

Index calculating section 111 obtains entropy H(X) with respect to signals of each channel according to equation 8. Entropy H(X) is then obtained by utilizing a speech signal typically approaching the exponential distribution (Laplace distribution) expressed in equation 9. α is defined using equation 12 described later.

$$\begin{matrix}[ 9 ] & \\ p ( x ) = \frac{α}{2} \cdot {e}^{- α \vert x \vert} & ( Equation 9 )\end{matrix}$$

Entropy H(X) expressed in equation 8 is calculated using equation 10 by using equation 9. Namely, entropy H(X) obtained from equation 10 indicates the number of bits necessary to represent one sample value and can therefore be used as an index indicating the degree of the speech information amount. In equation 10, as shown in equation 11, the average value of the amplitude of the speech signal is regarded as 0.

[10]

H(X)=1−log₂ α(bits/sample value) (Equation 10)

[11]

∫_{-∞}^{∞}p(x)|x|dx=0 (Equation 11)

However, in the case of exponential distribution, when standard deviation of a speech signal is taken to be σₓ, σ can be expressed using equation 12.

$$\begin{matrix}[ 12 ] & \\ α = \frac{\sqrt{2}}{{σ}_{x}} & ( Equation 12 )\end{matrix}$$

As described above, the average value of the absolute value of the amplitude of the speech signal can be regarded as 0, and therefore the standard deviation can be expressed as shown in equation 13 using power P of the speech signal.

[13]

σₓ=\sqrt{P} (Equation 13)

Equation 10 becomes as shown in equation 14 when equation 12 and equation 13 are used.

$$\begin{matrix}[ 14 ] & \\ H ( X ) = \frac{1}{2} ( 1 + {log}_{2} P ) & ( Equation 14 )\end{matrix}$$

As a result, when power of the L-channel signal is P_{L}, entropy H_{L} of each fixed length of segment of the L-channel signal can be obtained according to equation 15.

$$\begin{matrix}[ 15 ] & \\ {H}_{L} = \frac{1}{2} ( 1 + {log}_{2} {P}_{L} ) ( bits \text{/} sample value ) & ( Equation 15 )\end{matrix}$$

Similarly, when power of the R-channel signal is P_{R}, entropy H_{R} of each fixed length of segment of the R-channel signal can be obtained according to equation 16.

$$\begin{matrix}[ 16 ] & \\ {H}_{R} = \frac{1}{2} ( 1 + {log}_{2} {P}_{R} ) ( bits \text{/} sample value ) & ( Equation 16 )\end{matrix}$$

In this way, entropies H_{L} and H_{R} of signals of each channel can be obtained at index calculating section 111, and these entropies can be inputted to weighting coefficient calculating section 112.

As described above, entropies are obtained assuming that distribution of the speech signal is an exponential distribution, but it is also possible to calculate entropies H_{L} and H_{R} for signals of each channel from sample xᵢ of the actual signal and occurrence probability p(xᵢ) calculated from the frequency of occurrence of this signal.

Weighting coefficients W_{L} and W_{R} are calculated at weighting coefficient calculating section 112 according to equations 17 and 18 using entropies H_{L} and H_{R} as indexes I_{L} and I_{R} shown in Embodiment 1. Weighting coefficients W_{L} and W_{R} are then inputted to multiplying section 113.

$$\begin{matrix}[ 17 ] & \\ {W}_{L} = \frac{{H}_{L}}{{H}_{L} + {H}_{R}} & ( Equation 17 ) \\ [ 18 ] & \\ {W}_{R} = \frac{{H}_{R}}{{H}_{L} + {H}_{R}} & ( Equation 18 )\end{matrix}$$

In this way, in this embodiment, by using an entropy as an index indicating the speech information amount (the number of bits) and assigning weights to signals of each channel according to the entropy, it is possible to generate a monaural signal where signals of channels with a large amount of speech information are reinforced.

### Embodiment 3

In this embodiment, the case will be described where an S/N ratio of signals of each channel is used as an index indicating the rate of the speech information amount. In this case, index calculating section 111 calculates an S/N ratio as follows, and weighting coefficient calculating section 112 calculates weighting coefficients as follows.

The S/N ratio used in this embodiment is the ratio of main signal S to other signals N at the input signal. For example, when the input signal is a speech signal, this is the ratio of main speech signal S and background noise signal N. Specifically, the ratio of average power P_{S} of the inputted speech signal (where power in frame units of the inputted speech signal is time-averaged) and average power P_{E} of the noise signal at the non-speech segment (noise-only segment) (where power in frame units of non-speech segments is time-averaged), obtained from equation 19 is sequentially calculated, updated and taken as the S/N ratio. Further, typically, speech signal S is likely to be more important information than noise signal N for the listener. It is therefore possible to generate a monaural signal where information necessary for the listener is reinforced, using the S/N ratio as an index. In this embodiment, the S/N ratio is used as an index indicating the degree of the speech information amount.

$$\begin{matrix}[ 19 ] & \\ S \text{/} N = 10 {log}_{10} \frac{{P}_{S}}{{P}_{E}} & ( Equation 19 )\end{matrix}$$

From equation 19, the S/N ratio (S/N)_{L} of the L-channel signal can be expressed by equation 20 from average power (P_{S})_{L} of the speech signal for the L-channel signal and the average power (P_{E})_{L} of the noise signal for the L-channel signal.

$$\begin{matrix}[ 20 ] & \\ {( S \text{/} N )}_{L} = 10 {log}_{10} \frac{{( {P}_{S} )}_{L}}{{( {P}_{E} )}_{L}} & ( Equation 20 )\end{matrix}$$

Similarly, the S/N ratio (S/N)_{R} of the R-channel signal can be expressed by equation 20 from average power (P_{S})_{R} of the speech signal for the R-channel signal and the average power (P_{E})_{R} of the noise signal for the R-channel signal.

$$\begin{matrix}[ 21 ] & \\ {( S \text{/} N )}_{R} = 10 {log}_{10} \frac{{( {P}_{S} )}_{R}}{{( {P}_{E} )}_{R}} & ( Equation 21 )\end{matrix}$$

However, when (S/N)_{L} and (S/N)_{R} are negative, a predetermined positive lower limit is substituted with a negative S/N ratio.

In this way, S/N ratio (S/N)_{L} and (S/N)_{R} of signals of each channel can be obtained at index calculating section 111, and these S/N ratios are inputted to weighting coefficient calculating section 112.

Weighting coefficients W_{L} and W_{R} are calculated at weighting coefficient calculating section 112 according to equations 22 and 23 using S/N ratio (S/N)_{L} and (S/N)_{R} as indexes I_{L} and I_{R} described in Embodiment 1. Weighting coefficients W_{L} and W_{R} are then inputted to multiplying section 113.

$$\begin{matrix}[ 22 ] & \\ {W}_{L} = \frac{{( S \text{/} N )}_{L}}{{( S \text{/} N )}_{L} + {( S \text{/} N )}_{R}} & ( Equation 22 ) \\ [ 23 ] & \\ {W}_{R} = \frac{{( S \text{/} N )}_{R}}{{( S \text{/} N )}_{L} + {( S \text{/} N )}_{R}} & ( Equation 23 )\end{matrix}$$

The weighting coefficients may also be obtained as described below. Namely, the weighting coefficients may be obtained using an S/N ratio where a log is not taken, in place of an S/N ratio at a log region shown in equations 20 and 21. Further, instead of calculating a weighting coefficients using equations 22 and 23, it is possible to prepare a table in advance indicating a correspondence relationship between the S/N ratio and weighting coefficients such that the weighting coefficient becomes larger for the larger S/N ratio and then obtain weighting coefficients by referring to this table based on the S/N ratio.

In this way, in this embodiment, by using the S/N ratio as an index indicating the speech information amount and assigning weights to signals of each channel according to the S/N ratio, it is possible to generate a monaural signal where the signals of channels with a large amount of speech information are reinforced.

It is also possible to use regularity of a speech waveform (based on the speech information amount being larger for larger amounts of irregularity) and amount of variation over time of a spectrum envelope (based on the speech information amount being larger for the larger variation amount) as indexes indicating the degree of the speech information amount.

The speech encoding apparatus and speech decoding apparatus according to the above embodiments can also be provided on radio communication apparatus such as a radio communication mobile station apparatus and a radio communication base station apparatus used in mobile communication systems.

Also, in the above embodiments, the case has been described as an example where the present invention is configured by hardware. However, the present invention can also be realized by software.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC”, system LSI”, “super LSI”, or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The present application is based on Japanese patent application No. 2005-018150, filed on Jan. 26, 2005, the entire content of which is expressly incorporated by reference herein.

### INDUSTRIAL APPLICABILITY

The present invention can be applied to use for communication apparatuses in mobile communication systems and packet communication systems employing internet protocol.

1. A speech encoding apparatus comprising:
a weighting section that assigns weights to signals of each channel using weighting coefficients according to a speech information amount of signals for each channel of a stereo signal;
a generating section that averages the weighted signals for each channel so as to generate a monaural signal; and
an encoding section that encodes the monaural signal.

2. The speech encoding apparatus according to claim 1, wherein the weighting section calculates the weighting coefficients using an entropy of signals of each channel as the speech information amount.

3. The speech encoding apparatus according to claim 1, wherein the weighting section calculates the weighting coefficients using an S/N ratio of signals of each channel as the speech information amount.

4. A radio communication mobile station apparatus comprising the speech encoding apparatus according to claim 1.

5. A radio communication base station apparatus comprising the speech encoding apparatus according to claim 1.

6. A speech encoding method comprising:
a weighting step of assigning weights to signals of each channel using weighting coefficients according to a speech information amount of signals for each channel of a stereo signal;
a generating step of averaging the weighted signals for each channel so as to generate a monaural signal; and
an encoding step of encoding the monaural signal.
